(19) United States
(12) Patent Application Publication
(10) Pub. No.: US 2006/0088414 A1
(43) Pub. Date: Apr. 27, 2006

(54) Device to measure the axial displacement of the tip of the blades of a turbomachine for tests on the ground, and a process for using the device

(75) Inventors: Nadine Harivel, Vaux Le Penil (FR); Vincent Leignel, Melun (FR); Denis Andre Jean Lisiecki, Saint Jean Du Cardonnay (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA, Paris (FR)

(21) Appl. No.: 11/246,207

(22) Filed: Oct. 11, 2005

(30) Foreign Application Priority Data
Oct. 12, 2004 (FR) 04 52343

(51) Int. Cl. B64C 11/30

(52) U.S. Cl. 416/61

(57) ABSTRACT

The invention concerns a device for measuring the axial displacement of the blades of a turbomachine rotor, for tests on the ground. This device is characterised by the fact that it includes means for the taking and transmitting of images, and which is suitable for being installed opposite to the blades and connected to remote image acquisition means.

The invention concerns a device for measuring the axial displacement of the tip of the blades of a turbomachine for tests on the ground, and a process for using the device.

A turbojet generally includes a fan, one or more compressor stages, a combustion chamber, one or more turbine stages and a exhaust nozzle. The fan, the compressor and the turbine all have rotors whose blades are driven in rotation around the axis of the turbojet.

In operation, the rotary elements of the turbojet are subjected to many mechanical and thermal stresses which lead to expansions and movements within their structures. It is therefore important, before the finalising of the design of a turbojet, to conduct tests on the ground in order to quantify these movements and to dimension the structure of the turbojet accordingly.

The invention concerns measurement of the axial displacement of the tip of the blades of a turbomachine rotor, and in particular a turbojet rotor.

This measurement is generally effected with the machine in operation on the ground in a test rig. Use is made of a bar of optical fibres, positioned opposite to the blades in a bore created for this purpose in their retention housing. The bar consists of a line of juxtaposed optical fibres, into which light beams are transmitted. The beams are, or are not, reflected by the tips of the blades, according to whether they are opposite to the latter or not. The axial displacement of the blade tips is deduced from the number of fibres from which beams are reflected.

This device has several drawbacks. Firstly, its accuracy is poor and directly linked to the diameter of the optical fibres, which happens to be 0.25 mm. In addition, these optical fibres are fragile and have a non-negligible probability of rupture during the installation of the bar or its transportation. Now it is impossible to replace a single fibre in a bar when it has broken. In fact, the whole bar has to be replaced when a fibre breaks. Since a bar frequently has several hundreds of fibres measuring some ten or so metres, the cost of replacement is very high. The creation and the installation on the turbojet of such a device are also very constraining.

People have considered replacing this device with a camera, which has the advantage firstly of better resolution, and secondly of being far more robust. However, the dimensions of a camera are too great for it to be installed satisfactorily in a turbojet, which presents many obstacles around its periphery. A camera does not deal well with the vibrations inherent in the operation of a turbojet.

The invention aims to propose a device that gets around the disadvantages described above.

To this end, the invention concerns a device for measuring the axial displacement of the blade tips of a turbomachine rotor, for tests on the ground, characterised by the fact that it includes means for taking and transmitting images, and which is suitable for being installed opposite to the blades and connected to remote image acquisition means.

By means of the invention, it is possible to measure the axial displacement of the blade tips by means of a device whose means for taking and transmitting images have easy access to a point opposite to the blades, supplying images with a good definition by means of its image acquisition means, which are remote and therefore located in a place with few constraints, where the device has a life expectancy which is greater than that of the devices in previous designs.

It is preferable that the device should include means for the generation of light.

Advantageously in this case, the device includes means for synchronisation of the light generating means and of the image acquisition means.

Again advantageously, the synchronisation means are controlled by the rotation frequency of the blades.

It is preferable that the device should include image processing means connected to the image acquisition means.

According to a first form of implementation, the means for taking and transmitting the images include a fibrescope.

According to a second form of implementation, the means for taking and transmitting the images include an endoscope.

The invention also concerns a process for measuring the axial displacement of the blade tips of a turbomachine rotor for tests on the ground using the aforementioned device.

The invention applies particularly well to measurement of the axial displacement of the blade tips of a turbojet rotor, but it goes without saying that the applicant does not intend to limit the scope of its protection to this single application. The invention applies to any turbomachine that includes a rotor with blades. The expression “tests on the ground” refers to tests conducted on a test rig on the ground as opposed to tests on a turbojet in operation in the air.

The invention will be understood better through the following description of the device and of the process of the invention, with reference to the appended figures in which:

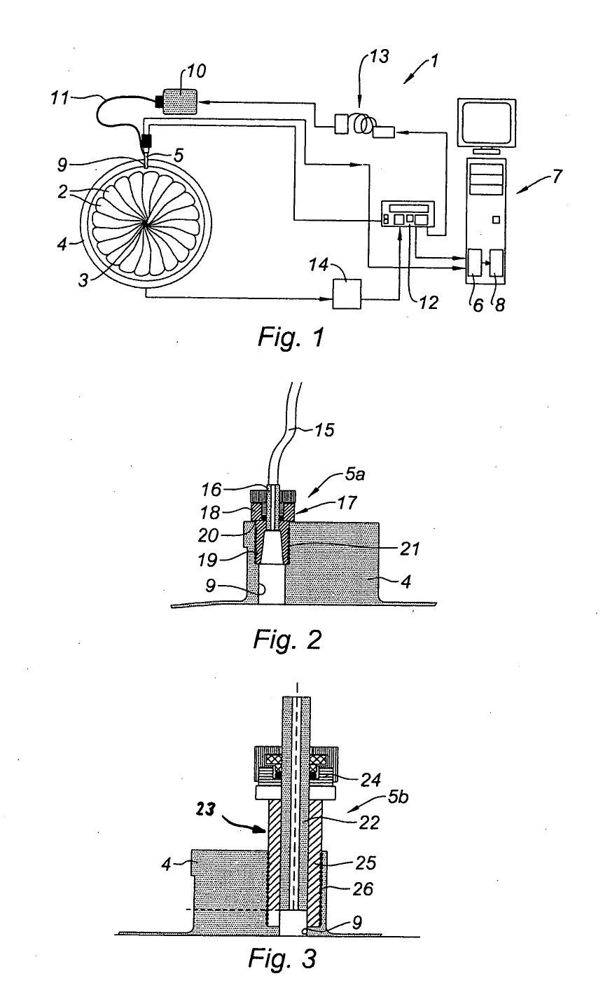

FIG. 1 is a functional schematic view of the device of the invention;

FIG. 2 is a schematic view in section of the optical probe of a first form of implementation of the device of the invention;

FIG. 3 is a schematic view in section of the optical probe of a second form of implementation of the device of the invention.

Because of the mechanical, aerodynamic and thermal operating constraints on all of the component elements of a turbojet, the tips of the blades of its rotors can undergo axial movements on the axis of the turbojet, between their position with the turbojet at the halt and their position in running mode. These movements must be measured, prior to the start-up of a turbojet, so as to be able to model the behaviour of the blades in operation and dimension the turbojet accordingly. To this end, devices are put in place for measuring the axial movements of the blade tips, for use during tests on the turbojet on the ground. In these tests, the turbojet is placed in a test rig and brought into operation.

Referring to FIG. 1, a device 1 for measuring the axial displacement of the blade tips of a turbojet rotor, in accordance with the invention, will be described in relation to measurement of the axial displacement of the blade tips 2 of a turbojet compressor. These blades 2 extend radially around the axis 3 of the turbojet, around which they are mounted in rotation. They are contained within a housing 4. The function of the device 1 is to measure the axial displacement of the blade tips 2 of the turbojet in operation, during tests on the ground.

The device includes means for the taking and transmitting of images 5, which here include an optical probe 5, which in this case can be a fibrescope or an endoscope, as will be seen later. The probe 5 is located in a bore 9 in the housing 4 of the compressor, specially drilled for the tests on the ground. It is placed opposite to the blades 2 in order to take images of their tips.

The optical probe 5 is connected to image acquisition means 6, whose function here is to convert the images into a digital video signal, and can include a digital camera or a sensor for example. In this present case, it is a digital camera 6 of the CCD type, which includes an electronic shutter that can be opened or closed in order to acquire images or not, respectively. The probe 5 takes the images at the position of the blades 2 and transmits these images to the camera 6. To this end, the camera 6 can either be connected to the probe 5 at the end opposite to that facing the blade tips 2, or can be connected to the probe 5 by additional means for transmission of the images, such as optical fibres.

The camera 6 is connected by appropriate means to means 8 for processing the video signal that it transmits. In this case, the camera 6 and the processing means 8 are both contained in a computer 7, represented schematically in FIG. 1 by a computer case and a monitor.

A light-generating device 10, in this case a stroboscope 10, is linked to the optical probe 5 by optical fibres 11. The light, guided by the optical fibres 11 suitably arranged close to the probe 5, illuminates the blade tips 2 when the stroboscope 10 emits a flash. A flash refers here to a brief emission of light. The stroboscope 10 and the camera 6 are both driven by a synchronising device 12, controlling the flashes of the stroboscope 10 and the electronic shutter of the camera 6. The synchronising device 12 is connected to the stroboscope 10 by means of optical coupling means 13 which are well known to the professional engineer. The synchronising device 12 is also connected to the camera 6, which it controls, and to the optical probe 5, which allows its control circuit to be connected in a loop. The turbojet also includes means for measuring engine speed, which here refers to the rotation frequency of the blades 2 of the compressor (not shown), connected to a divider 14 which controls the synchronising device 12, to which it is connected by appropriate means.

The operation of the device 1 for measuring the axial displacement of the blade tips 2 of the compressor will now be explained in greater detail, in relation to a particular measuring process. The device 1 is used here to measure the axial displacement of the blade tips 2 of the turbojet compressor, in this case the axial displacement of their leading edges. One could easily adapt the process to measure the axial displacement of their trailing edges.

The optical probe 5 is mounted in its retaining bore 9 in the turbojet housing 4. The probe 5 can include a thread to fit a corresponding thread in the bore 9, and/or it can be secured with a sealing gasket. The bore 9 is drilled from the outside of the housing 4 and emerges on its inner wall, close to the blade tips 2. The probe 5 includes an optical system for the taking and transmitting the images. In accordance with the two preferred forms of implementation of the invention, the probe 5 can be either a fibrescope or an endoscope, and these will be described later. A transparent window can be placed at the level of the internal orifice of the bore 9, so as to ensure the continuity of the gas stream and so not disrupt the flow of the latter, while still allowing image taking by the probe 5. However, in certain conditions, it is not necessary to provide a window, if the disruption induced by the orifice of the bore 9 is not too great, where the probe 5 also serves to seal the bore 9. Also, the probe 5 itself can ensure the continuity of the gas stream by virtue of its end part.

The probe 5 is connected to the image acquisition means 6, here the digital camera 6. The camera 6 can be directly connected to the probe 5, as long as it is not thereby placed in an excessively overcrowded part of the turbojet and that its operation will not be adversely affected in this location. For this measurement, it is best remoted from the imaging means. Indeed the camera 6 can be remoted even further, on a structure of the turbojet by example, connected to the probe by additional means for transmission of the images, such as optical fibres. In the two cases just mentioned, the camera 6 is then connected to the image processing means 8 by appropriate means, typically electrical conductors. The camera 6 can also be incorporated directly into the computer 7, as in the case in point, connected to the probe by optical fibres. Here, the computer 7 is located in a control room of the test rig in which the turbojet is placed, in this case some ten or so metres from the probe 5. It also includes the image processing means 8 to which the camera 6 is connected.

Here, the stroboscope 10 is placed on the turbojet, or close to the latter, and connected to the probe by optical fibres 11, placed in the arc of circle, closed or not, around the optical probe 5. The stroboscope emits light flashes which, by means of the optical fibres 11, illuminate the space of the turbojet located opposite to the probe 5 from the inside, and therefore any blade 2 passing this location at the moment of the flash.

In order to initialise the process, a blade 2 is placed opposite to the probe 5 and a first image is acquired at the halt, which gives the position of the blade tips 2 at the halt. To this end, the stroboscope 10 is lit in synchronism with the opening of the electronic shutter of the camera 6, which thus acquires the images of the blade tip 2, transmitted to it by the probe 5 and the optical fibres for image transmission. This first image acquisition also allows an optical adjustment to be effected on the probe 5 and an adjustment to be made to the power of the stroboscope 10 so as to obtain optimal contrast of the image. It also allows synchronisation of the emission of a flash by the stroboscope 10 with the opening of the camera shutter 6, so that the camera actually acquires an image when the flash is lit, that is when the blade tip 2 is illuminated.

The turbojet is then started up. When a predetermined speed has been reached, images are taken of the tip of a particular blade 2. The images can be taken continuously and simultaneously with the speed changes of the engine, the signal emitted by the camera 6 being a video signal. To this end, the synchronising device 12 is controlled by the divider 14. The latter is controlled by the engine-speed measuring device, which acts as a time base for the device. The divider 14 is arranged so as to send a signal to the synchronising device 12 every “n” revolutions of the turbojet. This signal causes the emission, by the synchronising device 12, of a signal to control the emission of a flash by the stroboscope 10 and for the synchronised acquisition of an image by the camera 6 by opening its shutter. Thus, on each trigger signal, the blade tip 2 is illuminated by the flash, and the camera shutter 6 is opened to acquire the image of the illuminated blade tip 2.

The number “n” is chosen to that the trigger signal always corresponds to the same blade 2. Thus, the same blade tip 2 is located opposite to the probe 5 at each emission of a flash by the stroboscope and every opening of the camera shutter 6. To this end, the synchronising device is initialised on this particular blade 2, henceforth called “the blade” 2, and divides the rotation frequency or frequency of passage of the blades 2 by “n”, so that each image is taken after n revolutions of the blade 2. The number “n” is arranged so as to obtain a frequency of the trigger signal which is equal to the acquisition frequency desired for the camera 6. In this case, the camera 6 is arranged to capture 50 images per second, and “n” is therefore arranged so that the rotation frequency of the blades 2, divided by “n”, is 50 Hz or close to 50 Hz.

The illumination time of the blade tip and the exposure time of the camera shutter 6 are calibrated in accordance with the speed of the turbojet in order to obtain images with the highest possible contrast, though these times should not be too short for the illumination and the acquisition to be satisfactory, depending on the sensitivity of the video sensors in the camera 6. The synchronisation of the stroboscope 10 and of the electronic camera shutter 6 is effected continuously in accordance with the speed of the turbojet. At each image acquisition, the whole synchronisation system, which is looped, is synchronised afresh in relation to the speed of the turbojet.

In this case, the camera 6 is an interlaced fields model, where each image is acquired as an image in which one line in every two of the frame scan is illuminated, alternatively one image in every two. The images are therefore acquired at 25 Hz for each of the two sets of lines of one line in every two. In order to obtain complete images to fill all of the frame scans, the images of each line are processed so that they can be interpolated by calculation between two successive acquisitions, and so that, for the unlit lines, the value calculated by interpolation can be assigned to them. It goes without saying that the images could be complete as soon as they have been acquired.

Other processes for acquisition of the images can also be envisaged. For example, the camera shutter 6 can remain open, and the flash illuminated only during the passage of the blade 2 every “n” revolutions. The video would then consist of dark periods, or periods just with the ambient light, and illuminated periods. Again, a constant light could illuminate the blades 2, with the camera shutter 6 set to be open only every “n” revolutions of the blade 2. However, since the opening and closing speed of the camera shutter 6 is lower that that of the on/off switching of the stroboscope 10, it would be better for the capture accuracy of the blade 2 to be determined by the stroboscope 10.

The images acquired by the camera 6 are processed in the processing means 8 located in the computer 7. When the images have been processed and have all their lines completed, they are then analysed. It may happen that some parasitic light, other than the light of the blade tip image 2, may appear on the images. This parasitic light can, in particular, come from various reflections from the housing that encloses the blades 2, such as on the sides of the blades 2 or their roots, or from reflections associated with the coupling between the optical fibres 11 of the stroboscope 10 and the probe 5. This parasitic light is filtered in the processing device 8, either by luminous thresholding of the image, or by removal of those parts of the image with identifiable parasitic light, which it is known cannot correspond to the blade tip 2. The “noise” in the signal, in particular associated with the ambient light, is also removed using a low-pass filter. The image of the blade tip 2 is thus extracted from the image. A search is then conducted for the point closest to the edge of the image, so as to take into account any misalignments of the probe 5 with the blade 2, by polling of the image from bottom to top for example, so as to ascertain the position of the blade tip 2.

The images are in digital format and are therefore composed of pixels. Since the objective of the process for using the device 1 is to measure the axial displacement of the blade tips 2, the positions of the blades 2 at the various speeds of operation of the turbojet are compared to their calculated positions at the halt. These pixel position differences must then be converted into distance. To this end, one can have effected, beforehand, the acquisition of images of a control object, of known dimensions, placed at a distance from the probe 5 which is approximately equal to that occupied by the blade tips 2, so as to calculate a factor for the conversion of pixels into millimetres, for example. As an example of this, for a fan, the axial movements of the blades are about 10 to 20 mm, being 5 to 10 mm for the high-pressure compressor of a double-flow turbojet, and 1 to 5 mm for a low-pressure compressor.

By means of the device of the invention and its operating process, it is therefore possible to perform measurements in real time of the axial movements of the blade tips on a turbojet in operation during tests on the ground, using image acquisition means that are remote in relation to the image taking means at the blade, to which they are connected by image transmission means. The frequency of image acquisitions in the device is adapted in real time to the operating mode of the turbojet.

The two preferred forms of implementation of the invention will now be described, with reference to FIGS. 2 and 3.

Referring to FIG. 2, according to a first form of implementation, the probe of the device 1 is a fibrescope 5a. It consists of a flexible optical cable 15 which includes a large number of parallel optical fibres, here some 10,000. The optical cable 15 is affixed to a ferrule 16, located in a sleeve 17 for attachment to the housing 4 of the compressor. The sleeve 17 includes a head portion 18, for connection of the fibres 11 linked to the stroboscope 10, in which the ferrule 16 is lodged, the latter being extended by a hollow tubular portion 19 that includes a shoulder 20 that bears onto the housing 4. The ferrule 16 can also extend into the tubular portion 19. The latter includes an external thread 21, which is screwed into a corresponding bore in the housing 4, thus guaranteeing the waterproofing of the assembly. The ferrule 16 emerges into the internal conduit of the tubular portion 19, which is extended by the bore 9 in the housing 4, and is therefore located opposite to the place of passage of the leading edge of the blade tips 2, of which it is taking images. The fibres 11 connected to the stroboscope 10 (not shown) here extend in the partial arc of a circle around the ferrule 16. The fibrescope 5a is connected directly to the camera 6 by its optical cable 15.

Because of the flexibility of these means for the transmission of images, namely the optical cable 15, the fibrescope 5a can be located in areas that are very difficult to reach and that are crowded. The images obtained are “diaphragmed” by the circular entry pupil of the ferrule window 16 forming the image taking means. In addition, the images are “discretised” because of the juxtaposition of the optical fibres.

Referring to FIG. 3, according to a second form of implementation, the probe of the device 1 is an endoscope 5b. It includes a rigid optical cable 22. This cable 22 typically includes a metal conduit in which the lenses are located in series, separated from each other by their focal lengths (not shown). The rigid optical cable 22 is housed in a sleeve 23 for connection to the housing 4 of the compressor. The sleeve 23 includes a head portion 24 for connection of the fibres 11 linked to the stroboscope 10, and a hollow tubular portion 25. The tubular portion 25 includes an external thread 26, which is screwed into a corresponding bore in the housing 4, thus providing waterproofing for the assembly. The optical cable 22 looks into the internal conduit of the tubular portion 25, which is extended by the bore 9 in the housing 4, and is therefore located opposite to the place of passage of the leading edge of the blade tips 2 of which it is taking images. The fibres 11 connected to the stroboscope 10 (not shown) here extend in the partial arc of a circle around the optical cable 22.

The camera 6 can be mounted at the outer end of the optical cable 22 using a coupler, if the dimensions so allow. The optical cable 22 therefore performs a function of image acquisition at its inner end, as well as a function of image transmission to the camera 6. The optical cable 22 can also be connected to other image transmission means, typically optical fibres, connected in their turn to the camera 6.

Because of the rigidity of its means for taking and transmitting images, namely the optical cable 22, the endoscope 5b is slightly more constraining to mount than the fibrescope 5a. On the other hand, the images that it takes are not discretised as with the fibrescope 5a, and the lighting can be better, thus providing images with better resolution. The field of the object filmed, though more precise, is nevertheless smaller, because of magnification by the lenses. This magnification also means that the apparent speed of the blades passing the endoscope 5b is so much greater, calling for better accuracy of the image acquisition process, so that the images are not excessively blurred and do not leave excessive trails or lines because of the movement of the blades.

1. A device for measuring the axial displacement of the blades of a turbomachine rotor, for tests on the ground, characterised by the fact that it includes means for taking and transmitting images, suitable to be installed opposite to the blades and connected to remote image acquisition means.

2. A device in accordance with claim 1, that includes light generating means.

3. A device in accordance with claim 2, that includes means for synchronisation of the light generating means and of the image acquisition means.

4. A device in accordance with claim 3, in which the synchronisation means are controlled by the rotation frequency of the blades.

5. A device according to claim 1, that includes image processing means connected to the image acquisition means.

6. A device according to claim 1, in which the means for the taking and transmitting of images include a fibrescope.

7. A device according to claim 1, in which the means for the taking and transmitting of images include an endoscope.

8. A device according to claim 1, in which the image acquisition means include a camera of the CCD type.

9. A process for measuring the axial displacement of the blades of a turbomachine rotor, for tests on the ground, with the device of claim 4 in which the synchronisation means emit a trigger signal for the light generating means and for the image acquisition means on each passage of a particular blade every “n” revolutions.

10. A measurement process in accordance with claim 9, in which the position of the blades is measured beforehand with the turbomachine at the halt.
